(19) United States
(12) Patent Application Publication
(10) Pub. No.: US 2006/0088008 A1
(43) Pub. Date: Apr. 27, 2006

(54) Method and device for controlling power in mobile terminal

(75) Inventor: Seong-Joong Kim, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/259,722

(22) Filed: Oct. 26, 2005

(30) Foreign Application Priority Data
Oct. 26, 2004 (KR) 85862/2004

(51) Int. Cl. H04J 3/00; H04B 7/212

(52) U.S. Cl. 370/336; 370/442

(57) ABSTRACT

Disclosed is a method and device for controlling power in a mobile Internet terminal which includes a transmitter and a receiver for transmitting and receiving frames each consisting of an uplink frame and a downlink frame to and from a base station. The method includes the steps of receiving information as to whether effective data is present in the uplink frame or the downlink frame from the base station; supplying power to the transmitter during a period in which effective uplink data is present according to the received information; and supplying power to the receiver during a period in which effective downlink data is present according to the received information. The device also includes a power controller for receiving information as to whether effective data is present, and supplying power to the transmitter or receiver during a period in which effective uplink data or downlink data are respectively present.

### PRIORITY

This application claims priority to an application entitled “Method and Device for Controlling Power in Mobile Terminal” filed with the Korean Intellectual Property Office on Oct. 26, 2004 and assigned Serial No. 2004-85862, the contents of which are incorporated herein by reference.

### BACKGROUND OF THE INVENTION

1. Field of the Invention

The present invention relates to a mobile Internet terminal and, more particularly, to a method and device for controlling power supplied to a transmitter or a receiver at a mobile Internet terminal.

2. Description of the Related Art

New wireless Internet services which will soon be commercialized in the name Wireless Broadband (WiBro) are designed to provide high-speed wireless Internet access through a notebook computer or a mobile phone. To support WiBro commercialization, mobile phone providers are struggling to developing mobile Internet terminals that meet the demand for WiBro services.

Mobile Internet terminals are required to process signals with a very high Peak To Average Power Ratio (PAPR), over 10 Db, for high-speed data transmission. Accordingly, mobile Internet terminals for transmitting and receiving high PAPR signals have higher power consumption than conventional mobile phones for transmitting and receiving low PAPR level signals. To provide extended operation with the charged battery power used by the mobile Internet terminals, it is necessary to reduce PAPR and overall power consumption.

### SUMMARY OF THE INVENTION

Accordingly, the present invention has been made to solve the above-mentioned problems occurring in the prior art. An object of the present invention is to provide a method and device for controlling and reducing power consumption in a mobile Internet terminal.

Another object of the present invention is to provide a method and device for reducing power consumption in a mobile Internet terminal by controlling the power supplied to a transmitter or a receiver of the terminal according to a transmission period of an uplink frame or a receiving period of a downlink frame.

Still another object of the present invention is to provide a method and device for reducing power consumption in a mobile Internet terminal by controlling the power supplied to a transmitter or a receiver of the terminal according to a transmission period of effective uplink data or a receiving period of effective downlink data.

In accordance with one aspect of the present invention for accomplishing the above objects, a method is provided for controlling power in a mobile Internet terminal which includes a transmitter and a receiver for transmitting and receiving frames each consisting of an uplink frame and a downlink frame to and from a base station. The method includes the steps of receiving information as to whether effective data is present in the uplink frame or the downlink frame from the base station; supplying power to the transmitter during a period in which effective uplink data is present according to the received information; and supplying power to the receiver during a period in which effective downlink data is present according to the received information.

In accordance with another aspect of the present invention, a device is provided for controlling power in a mobile Internet terminal for transmitting and receiving frames, each consisting of an uplink frame and a downlink frame to and from a base station. The device includes a transmitter for sending the uplink frame to the base station; a receiver for receiving the downlink frame from the base station; and a power controller for receiving information as to whether effective data is present in the uplink frame or the downlink frame from the base station, for supplying power to the transmitter during a period in which effective uplink data is present according to the received information, and for supplying power to the receiver during a period in which effective downlink data is present according to the received information.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates the structure of a frame for a mobile Internet access;

FIGS. 2 and 3 illustrate the detailed structure of the frame in FIG. 1;

FIG. 4 are waveforms of signals for controlling power supplied to a transmitter and a receiver according to the present invention;

FIG. 5 are waveforms of signals for controlling power supplied to a transmitter and receiver where a large volume of downlink data and substantially little uplink data transmission exist;

FIG. 6 illustrates the structure of a mobile Internet terminal according to the present invention; and

FIG. 7 is a flow chart showing the operations of the modem in FIG. 6.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted to keep the subject matter of the present invention clear.

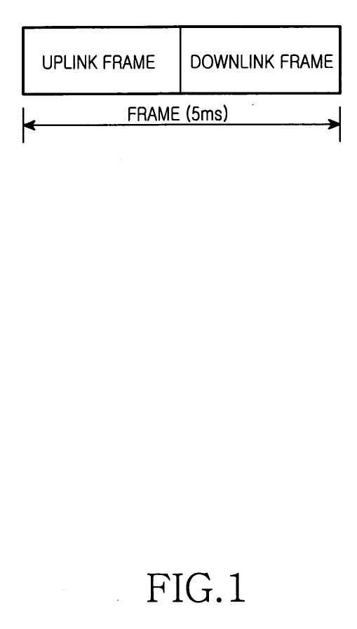

Mobile Internet service systems based on the new WiBro technology are Time Division Duplex (TDD) systems which alternate uplink and downlink transmissions during respectively allocated time slots. As illustrated in FIG. 1, frames in a mobile Internet service system are each divided into an uplink frame and a downlink frame.

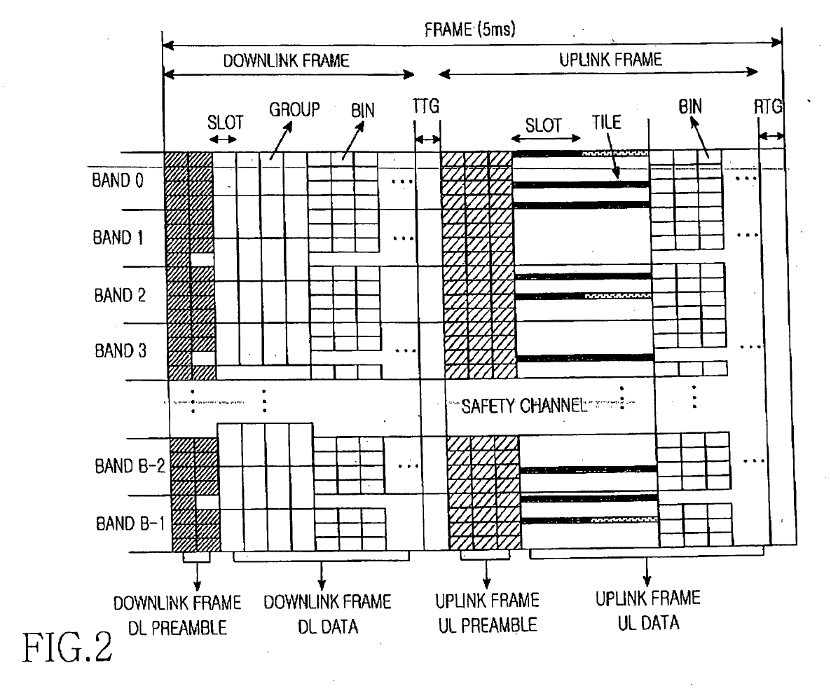

FIG. 2 illustrates the detailed structure of a frame consisting of an uplink frame and a downlink frame. The downlink frame consists of a downlink preamble and downlink data containing slots, groups and bins. The downlink frame ends with a transmit transition gap (TTG) of 121.2 microsecond which is a transition gap for separating the downlink frame from the subsequent uplink frame. The uplink frame consists of an uplink preamble and uplink data which contains slots, tiles and bins. The uplink frame ends with a receive transition gap (RTG) of 40.4 microsecond.

The downlink and uplink frame layouts will be explained in more detail. In both downlink and uplink, there are two kinds of subchannels, diversity subchannels and Adaptive Modulation and Coding (AMC) subchannels. Both subchannels have a separate transmission period consisting of consecutive symbols. In downlink, a diversity subchannel consists of 54 subcarriers distributed in a single symbol. In uplink, a diversity channel consists of 6 tiles, each of which is made up of 3 contiguous subcarriers in 3 consecutive symbols. The 6 tiles are spread over the whole frequency band in uplink. The basic allocation unit for an AMC subchannel is a bin which is made up of 8 contiguous subcarriers in a same symbol. There are 4 bins in a single band. One AMC subchannel consists of 6 contiguous bins in a same band.

As explained above, an uplink frame and a downlink frame are not mixed, but are separated in a mobile Internet service system. Accordingly, the present invention provides a solution for supplying power only to the transmitter of a mobile Internet terminal during the uplink frame period, while supplying power only to the receiver of the mobile Internet terminal during the downlink frame period.

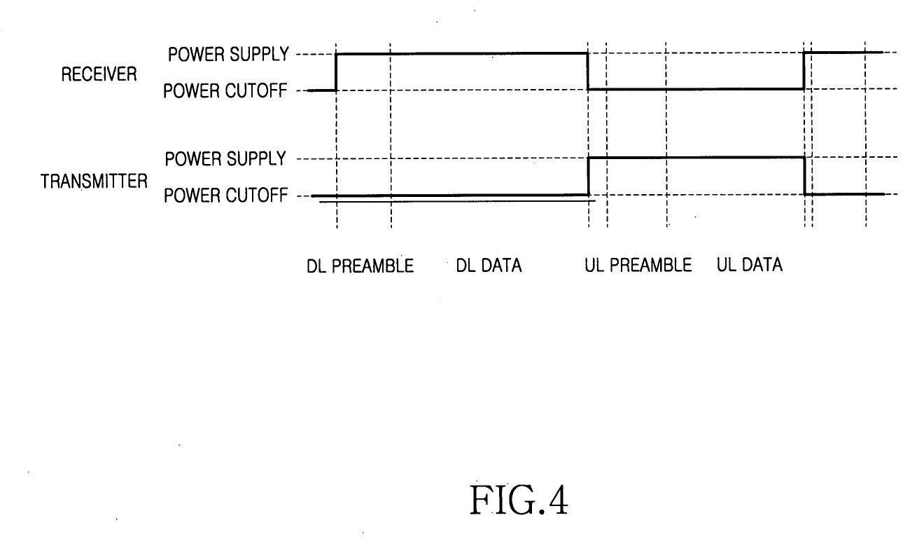

FIG. 4 illustrates a waveform of a signal for controlling power supplied to the transmitter and receiver of the mobile Internet terminal. A modem for controlling power in the mobile Internet terminal supplies power only to the receiver during a downlink frame period, cutting off the power supplied to the transmitter. Conversely, the modem supplies the power only to the transmitter during an uplink frame period. Alternating the power supplied to the receiver or the transmitter according to the downlink or uplink transmission period can reduce the power consumption in the mobile Internet terminal.

In a mobile Internet service system, it is very important to obtain synchronization between a mobile Internet terminal and a base station. For synchronization, the base station determines the order of all data transmissions in frames. The transmission order determined by the base station is indicated in the Downlink Mobile Application Part (DL MAP) and Uplink MAP (UL MAP) in each frame.

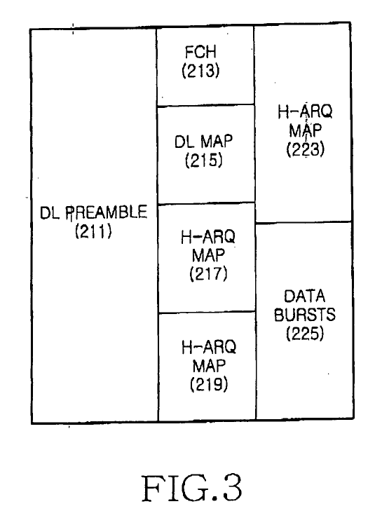

DL MAP and UL MAP are now explained in detail referring to FIG. 3. The downlink frame begins with a preamble followed by a frame control header (FCH). Immediately following the FCH are DL MAP and Hybrid-Automatic Repeat Request (H-ARQ) MAP in which DL MAP and UL MAP are both present.

DL MAP and UL MAP specify information elements (IEs) and profiles of the bursts transmitted in downlink or uplink. DL MAP is encoded by 1/2 Convolutional Turbo Code (CTC) coding, modulated by quadrature phase shift keying (QPSK) and applied with n repetition codes. The number of repetitions and the number of subchannels allocated to DL MAP are transmitted through the FCH.

Allocation information of H-ARQ MAP is defined as IEs in DL MAP. H-ARQ MAP is allocated subchannels, starting from the lowest numbered subchannel in the lowest orthogonal frequency-division multiple access (OFDMA) symbol index among the resources excluding those occupied by FCH, DL MAP and bursts allocated by DL MAP.

Downlink bursts allocated by H-ARQ MAP start from the lowest numbered subchannel in the lowest OFDMA symbol index among the remaining resources. In H-ARQ MAP, UL allocation for bursts is applied to the symbols following the first three OFDMA symbols which are used for uplink control symbols and starts from the lowest-index subchannel in the lowest OFDMA symbol index among the remaining resources.

According to the present invention, the mobile Internet terminal detects the location of any effective data (uplink frame or downlink frame) through DL MAP and UL MAP. The terminal supplies power to the transmitter only when effective uplink data is detected. Similarly, the terminal supplies power to the receiver only when effective downlink data is detected.

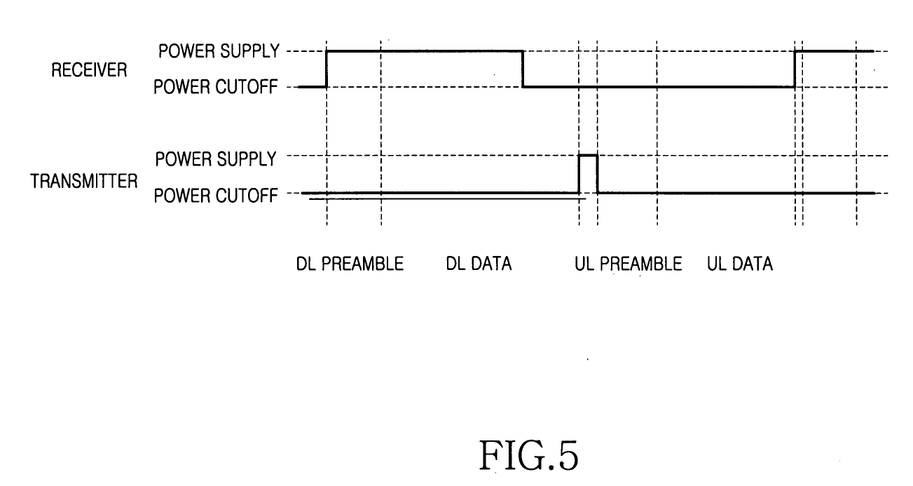

The process of controlling power supplied to the transmitter and receiver of the mobile Internet terminal will be explained in more detail with reference to FIG. 5. During mobile Internet access for Web surfing, a user generally receives a large volume of downlink data, with substantially no uplink data transmission. When there is no effective uplink data, the mobile Internet terminal does not supply power to the transmitter as shown in FIG. 5, thereby preventing excessive power consumption resulting from the unnecessarily supplying power to the transmitter when there is no data to be transmitted. In other words, the mobile Internet terminal can control and reduce the power consumption by supplying power to the transmitter or the receiver only when there is effective uplink or downlink data, respectively.

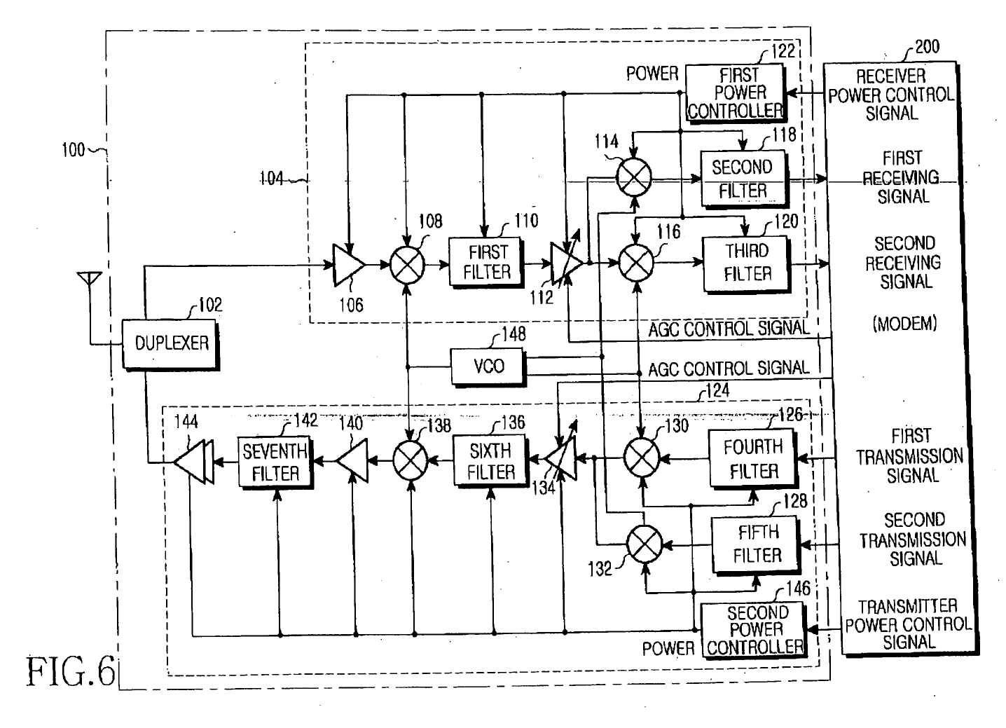

FIG. 6 illustrates the schematic structure of a mobile Internet terminal capable of controlling the power supply according to the present invention. A modem 200 of the mobile Internet terminal converts an uplink frame into corresponding first and second transmission signals and sends the signals to the base station through a transmitter 124. Also, the modem 200 receives first and second receiving signals corresponding to a downlink frame from the base station through a receiver 104. The modem 200 extracts DL MAP and UL MAP contained in the downlink frame and controls the power supply to the receiver 104 and the transmitter 124 based on information about the effective data period included in the extracted DL MAP and UL MAP. In addition, the modem 200 controls the operations of auto-gain controllers (AGCs) included in the receiver 104 and the transmitter 124.

A transceiver 100 of the mobile Internet terminal consists of a duplexer 102, receiver 104 and transmitter 124. The duplexer 102 connects an antenna to the receiver 104 or the transmitter 124, thereby enabling both transmission and receiving with a single antenna.

The receiver 104 includes a first low noise amplifier (LNA) 106 for amplifying a signal received through the duplexer 102; a first mixer 108 for mixing an output signal from the first LNA with a first frequency provided from a voltage controlled oscillator (VCO) 148; a first filter 110 for filtering an output from the first mixer 108; a first auto-gain controller (AGC) 112 for automatically controlling the gain of an output from the first filter 110 under the control of the modem 200; second and third mixers 114 and 116 for mixing an output from the first AGC 112 respectively with second frequencies having a 90° phase difference; second and third filters 118 and 120 for filtering outputs from the second and third mixers 114 and 116; and a first power controller 122 for supplying or cutting off the power to each part of the receiver 104 under the control of the modem 200.

The transmitter 124 includes fourth and fifth filters 126 and 128 for filtering first and second transmission signals outputted from the modem 200; fourth and fifth mixers 130 and 132 for mixing the first and second signals outputted from the fourth and fifth filters 126 and 128 respectively with second frequencies having a 90° phase difference; a second AGC 134 for receiving a sum of outputs from the fourth and fifth mixers 130 and 132 and automatically controlling the gain of the sum under the control of the modem 200; a sixth filter 136 for filtering an output from the second AGC 134; a sixth mixer 138 for mixing an output from the sixth filter 136 with the first frequency; a second LNA 140 for amplifying an output from the sixth mixer 138; a seventh filter 142 for filtering an output from the second LNA 140; a power amplifier (PA) 144 for power amplifying an output from the seventh filter 142 and providing the amplified output to the duplexer 102; and a second power controller 146 for supplying or cutting off the power to each part of the transmitter 124 under the control of the modem 200.

The VCO 148, included in the transceiver 100, generates a first frequency for converting an IF signal into an RF signal (or vice versa) and a second frequency for converting an IF signal into a baseband signal (or vice versa). The second frequency is output both with and without a delay so as to provide two signals with a 90° phase difference.

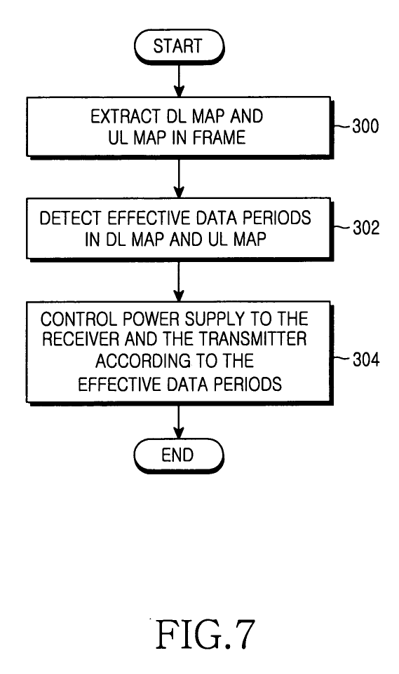

Hereinafter, a process of controlling power in a mobile Internet terminal according to the present invention will be explained in detail with reference to the flow chart of FIG. 7. When a frame is received from the base station, the modem 200 of the mobile Internet terminal extracts DL MAP and UL MAP from DL MAP and H-ARQ MAP in the downlink sub-frame of the received frame (step 300). Using the extracted DL MAP and UL MAP (step 302), modem 200 detects an effective downlink data period and an effective uplink data period. The modem 200 controls the power supplied to the receiver 104 and transmitter 124 of the transceiver 100 according to the detected downlink and uplink data periods (step 304). In other words, the modem 200 controls power supply so that the transmitter 124 can be powered on only when effective uplink data is detected and that the receiver 104 can be powered on only when effective downlink data is detected. The controlled power supply to the transmitter and the receiver can prevent excessive power consumption resulting from the unnecessarily supplying power when there is the lack of effective data to be transferred.

As explained above, the mobile Internet terminal can reduce the power consumption in the mobile Internet terminal by controlling power supplied to the transmitter and the receiver according to the transmission period of an uplink frame and the receiving period of a downlink frame.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for controlling power in a mobile Internet terminal which includes a transmitter for transmitting frames and a receiver for receiving frames, each consisting of an uplink frame, and a downlink frame to and from a base station, which comprises the steps of:
supplying power to the transmitter and cutting off power supplied to the receiver during an uplink frame period; and
supplying power to the receiver and cutting off power supplied to the transmitter during the downlink frame period.

2. A method for controlling power in a mobile Internet terminal which includes a transmitter for transmitting frames and a receiver for receiving frames, each consisting of an uplink frame, and a downlink frame to and from a base station, which comprises the steps of:
receiving information as to whether effective data is present in the uplink frame or the downlink frame from the base station;
supplying power to the transmitter during a period in which effective uplink data is present according to the received information; and
supplying power to the receiver during a period in which effective downlink data is present according to the received information.

3. The method as claimed in claim 2, wherein said information as to whether effective data is present in the uplink frame or the downlink frame is in DL MAP and UL MAP.

4. A device for controlling power in a mobile Internet terminal for transmitting frames and receiving frames, each consisting of an uplink frame and a downlink frame, to and from a base station, which comprises:
a transmitter for sending the uplink frame to the base station;
a receiver for receiving the downlink frame from the base station; and
a power controller for receiving information as to whether effective data is present in the uplink frame or the downlink frame from the base station, supplying power to the transmitter during a period in which effective uplink data is present according to the received information, and supplying power to the receiver during a period in which effective downlink data is present according to the received information.

5. The device as claimed in claim 4, wherein said information as to whether effective data is present in the uplink frame or the downlink frame is in DL MAP and UL MAP.
